(19) United States
(12) Patent Application Publication
(10) Pub. No.: US 2025/0244973 A1
(43) Pub. Date: Jul. 31, 2025

(54) Generating Graphical User Interface Designs Using Natural Language Processing

(71) Applicant: ServiceNow, Inc., Santa Clara, CA (US)

(72) Inventors: Chaitanya Saragadam, Hyderabad (IN); Avishek Dalal, Hyderabad (IN); Suhas K. S., Bangalore (IN); Gaurav Goyal, Santa Clara, CA (US)

(21) Appl. No.: 18/425,506

(22) Filed: Jan. 29, 2024

(51) Int. Cl. G06F 8/38; G06F 8/35

(52) U.S. Cl. CPC G06F 8/38; G06F 8/35

(57) ABSTRACT

An example implementation may involve: obtaining a textual prompt; based on the textual prompt, generating, via at least a natural language processing (NLP) model, relational data indicating respective relationships between components of a graphical user interface (GUI); and generating, based on the relational data, an implementation-specific representation of the GUI that is compatible with a GUI design tool.

### BACKGROUND

Graphical user interface (GUI) design tools are software applications used for creating, prototyping, and collaborating on user interface designs for websites, standalone applications, dedicated client applications, and/or mobile applications. These tools provide a suite of features that facilitate creation of detailed and interactive GUI designs. Such features may include selection of design artifacts (e.g., buttons, menus, and other widgets), graphical editing of shapes, icons, and visual elements, alignment mechanisms for arranging these and other GUI aspects, interactive prototyping and collaboration, and so on. Such a GUI design may be used as a reference for implementing a GUI in software.

However, even with these GUI design tools, the GUI design process remains inefficient and cumbersome. In some circumstances, generating a basic GUI structure includes generation of a wireframe. Generating a wireframe may be computationally expensive and time consuming. Further, a GUI design is typically revised multiple times to meet design requirements and based on stakeholder feedback, resulting in even a greater computational cost. Moreover, finalizing a GUI design with transitions, animations, and/or hover effects, for example, can be technically complicated. Thus, implementing these features into a formal and complete GUI design can be a time-intensive process, even with previously available tools.

### SUMMARY

Various implementations disclosed herein overcome these and possibly other limitations by enabling generation of GUI designs in native GUI design tool format through use of one or more text prompts. Particularly, these implementations introduce an iterative process for employing natural language processing (NLP) and pre-established embeddings to generate an implementation-neutral representation of a GUI.

The NLP aspects may be invoked locally or by way of an application programming interface (API), and may incorporate queries to and responses from a large language model (LLM). The embeddings may also be invoked locally or by way of an API, and may incorporate queries to and responses from a similarity-based model. The implementation-neutral representation may be in the form of metadata that defines a GUI design in a tree-like structure of GUI components. The GUI components may include text, still images, animations, sounds, or any combination thereof. A converter may transform the implementation-neutral representation into an implementation-specific design format. Here, the implementation-specific design format may be arranged to be operable with a specific GUI design tool (e.g., as an input file thereto).

In this manner, a GUI design can be specified and revised through use of textual descriptions that are transformed into GUI designs. The generated GUI designs can be viewed and manipulated in a GUI design tool. These GUI designs are inherently consistent in terms of theme (e.g., graphics, colors, and fonts). As a consequence, the GUI design process can be reduced from taking days or weeks to taking hours.

Accordingly, a first example embodiment may involve obtaining a textual prompt; based on the textual prompt, generating, via at least an NLP model, relational data indicating respective relationships between components of a GUI; and generating, based on the relational data, an implementation-specific representation of the GUI that is compatible with a GUI design tool.

A second example embodiment may involve a non-transitory computer-readable medium, having stored thereon program instructions that, upon execution by a computing system, cause the computing system to perform operations in accordance with any of the previous example embodiments.

In a third example embodiment, a computing system may include at least one processor, as well as memory and program instructions. The program instructions may be stored in the memory, and upon execution by the at least one processor, cause the computing system to perform operations in accordance with any of the previous example embodiments.

In a fourth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts an overall architecture for a text-to-design process, in accordance with example embodiments.

FIG. 7 depicts an LLM service, in accordance with example embodiments.

FIG. 8A depicts an embedding service, in accordance with example embodiments.

FIGS. 8B and 8C depict definitions of GUI layout templates that can be used with the embedding service, in accordance with example embodiments.

FIG. 9A depicts a procedure for generating a GUI design in an implementation-neutral design format, in accordance with example embodiments.

FIGS. 9B, 9C, 9D, 9E, 9F, 9G, 9H, 9I, 9J, 9K, and 9L depict incremental construction of a context that specifies a GUI design, in accordance with example embodiments.

FIG. 10A depicts converting a GUI design to an implementation-specific design format, in accordance with example embodiments.

FIG. 10B depicts representations of a GUI component and its corresponding design artifact, in accordance with example embodiments.

FIG. 11 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or extensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

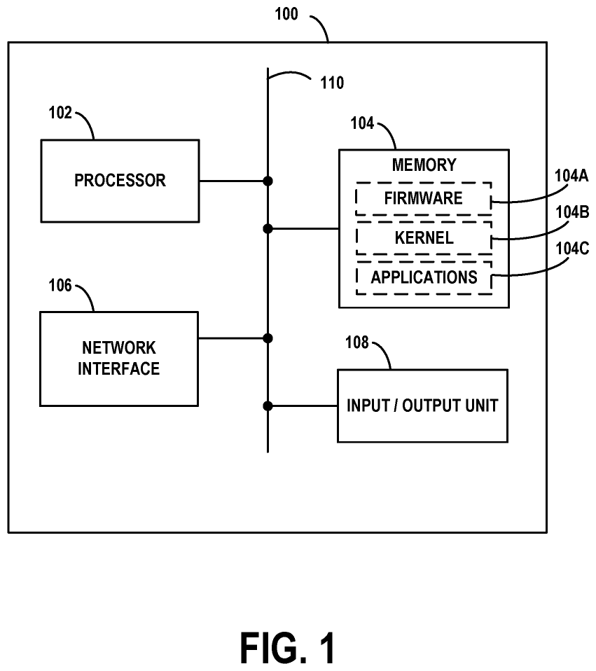

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), another form of co-processor (e.g., a mathematics or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Data Over Cable Service Interface Specification (DOCSIS), or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

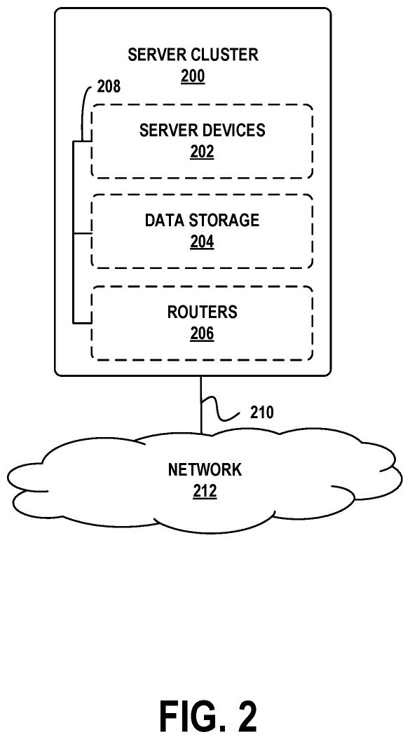

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

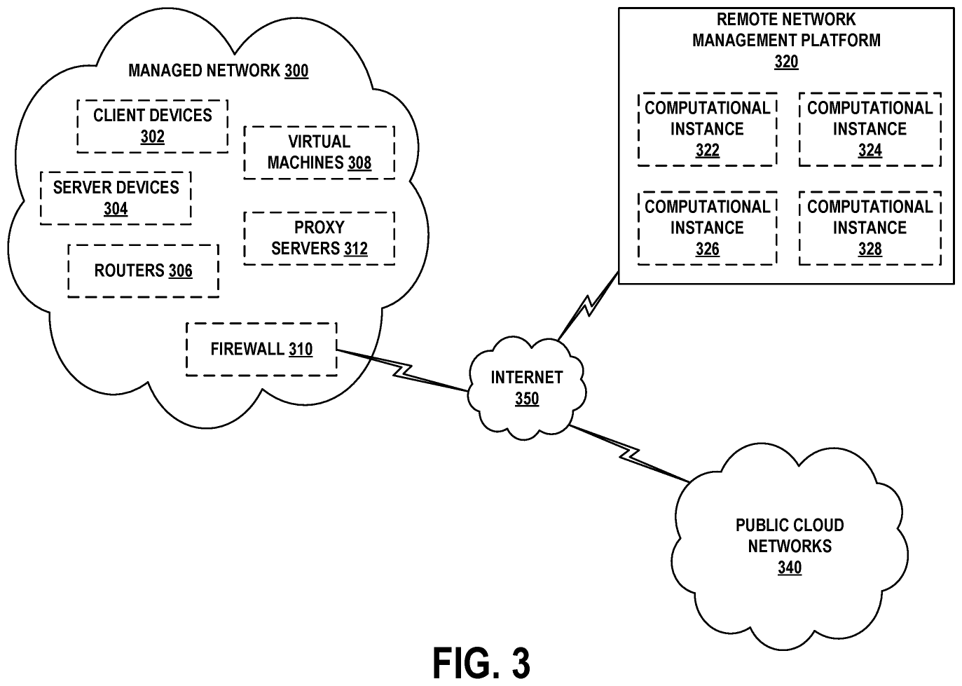

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

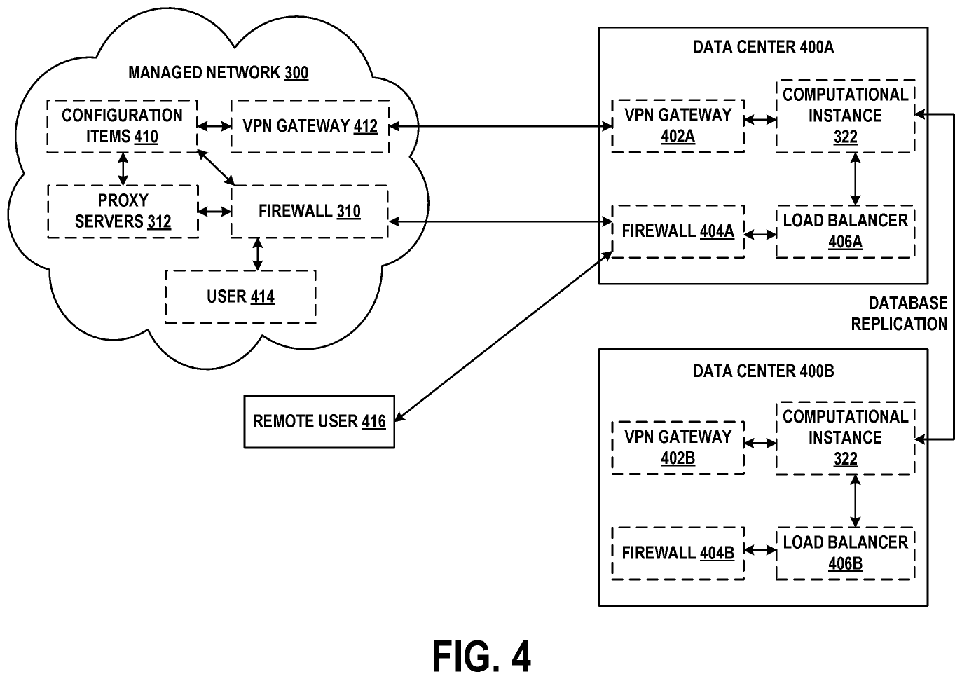

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### IV. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

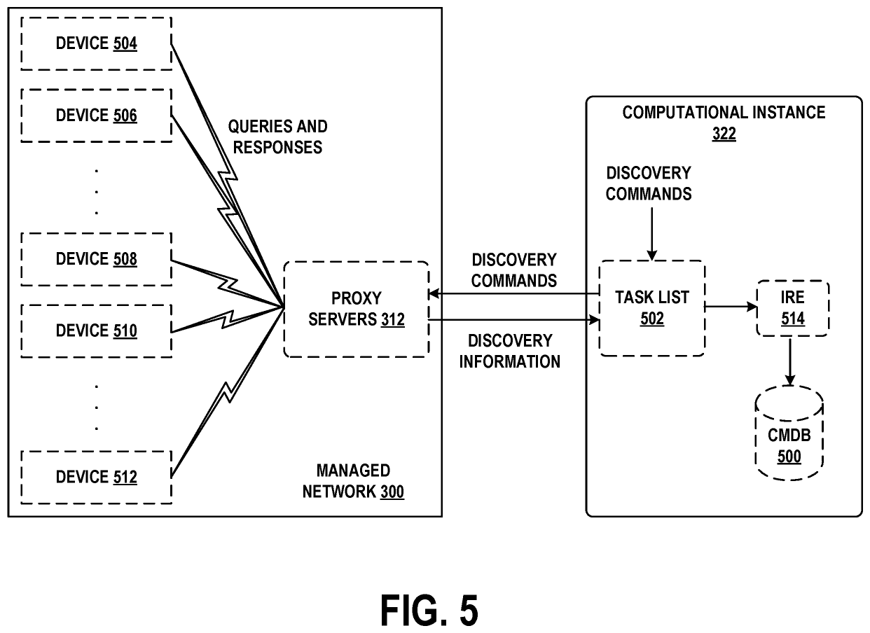

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery—horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases—under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### V. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VI. Graphical User Interfaces and Components

Graphical user interfaces (GUIs) may consist of one or more screens, with each screen including a set of GUI components. Such GUI components may include buttons, non-editable text labels, text boxes (e.g., for text entry by a user), check boxes, radio buttons, drop-down menus or lists, list boxes with selectable list items, sliders, charts, graphs, panels (sections of an interface that may contain other GUI components), progress indicators (e.g., progress bars), menu bars, tool bars, tabbed controls, dialog boxes, scroll bars, image viewers (e.g., a container to display an image or icon), tooltips (e.g., a pop-up box that provides context information when hovered over or actuated), separators, various types of cards, and so on. Some GUI components may serve as containers for other GUI components (e.g., panels as noted above or list boxes containing list items).

This list of GUI components is not comprehensive. More or fewer types of GUI components may be used in various graphical user interfaces. Further, different names may be used to refer to these GUI components (e.g., a panel may also be called a pane, a container, or a box).

Each of these GUI components may have a number of properties, including a size (e.g., dimensions in pixels, inches, or centimeters), a position (e.g., defined by the top left corner of the GUI component in either relative or absolute coordinates), one or more colors (e.g., a background color and a foreground color), a style (e.g., a font, font size, and/or or line weight), a visibility (e.g., shown or hidden), validation rules (e.g., for text entry), and/or custom event handling routines or scripts. Other GUI components may have additional properties that are hard-coded or configurable.

When rendered on a graphical user interface, these GUI components inherently exhibit a hierarchical structure. For example, the hierarchy may be tree-like, with the screen itself being the root node of the tree and the GUI components being arranged as children of the root node or of other GUI components. Such a tree-like hierarchy can be helpful when representing the GUI components in a data structure, as the data structure encodes the visual layout of the GUI components with respect to one another.

In general, a GUI component is a reusable and modular element that can be embedded into a web-based interface or custom application. A GUI component is typically defined using web technologies such as JavaScript, HTML, and CSS within a web-based framework. But other GUI frameworks, such as ANGULAR® or REACT® may be used. ANGULAR®, for example, allows GUI component appearance, data bindings, and behaviors to be specified in an object-oriented programming language. REACT® uses a combination of JavaScript and HTML to achieve a similar goal.

GUI components provide a way to encapsulate and package functionality, making it easier to build and maintain complex user interfaces. In addition to being reusable (thus promoting interface consistency and development efficiency), GUI components can be customized and interactively respond to actions or events.

### VII. Example Text-to-Design Implementation

Software applications known as GUI design tools are employed in the development, prototyping, and collaboration related to user interface designs pertinent to various platforms, including websites, standalone applications, client-specific applications, and mobile applications. These design tools encompass a comprehensive array of features intended to facilitate GUI designers in crafting intricate and dynamic GUI designs. Among the features offered are the generation of reusable GUI components such as buttons, menus, and additional widgets, graphical editing capabilities for the formation of shapes, icons, and visual elements, and alignment tools for the organization of these GUI components. Additionally, these GUI design tools enable interactive prototyping and collaborative efforts. Subsequent to the design phase, software engineers utilize the resulting GUI designs as a foundation and as guidelines for implementing GUIs in software.

Despite the availability of such GUI design tools, the process of GUI design remains a complex endeavor. GUI designers often construct wireframes (e.g., simple line and block diagrams of a GUI) as a preliminary step to establish the fundamental structure of the GUI design. This stage demands meticulous planning and careful deliberation. Moreover, GUI designs typically undergo several iterations, each aimed at refining the GUI design to align with specific requirements and incorporating feedback from stakeholders. Furthermore, the inclusion of advanced design elements such as transitions, animations, and hover effects into a GUI design poses technical challenges. Consequently, the integration of these features into a formalized and complete GUI design, even when utilizing advanced GUI design tools, constitutes a process that is both technically demanding and time-consuming.

The implementations described herein overcome these and possibly other limitations by enabling GUI designers to generate GUI designs in a native GUI design tool format through use of one or more text prompts. Particularly, these implementations introduce an iterative process for employing natural language processing (NLP) and pre-established embeddings of GUI templates and GUI components to generate an implementation-neutral representation of a content tree that defines a GUI. This process may be referred to as “text-to-design.”

The NLP aspects may be invoked locally or by way of an application programming interface (API), and may incorporate queries to and responses from a large language model (LLM). The embeddings may also be invoked locally or by way of an API, and may incorporate queries to and responses from a similarity-based model. The implementation-neutral representation may be in the form of metadata that defines a GUI in a tree-like structure of GUI components. A converter may transform the implementation-neutral representation into an implementation-specific design format. Here, the implementation-specific design format may be arranged to be compatible with a specific design tool (e.g., as an input file thereto).

Examples of supported design tools include one or more of FIGMA®, INVISION®, MIRO®, and various ADOBE® software packages. Advantageously, the implementation-neutral representation can be converted to implementation-specific design formats for any of these packages.

In this manner, a GUI designer can specify and revise a GUI design through use of text prompts. These GUI designs can be transformed into a format that can be viewed and manipulated in a GUI design tool. As a consequence, the GUI design process can be reduced from taking days or weeks to taking hours. With finalized GUI designs in hand, software developers can code the actual GUIs for deployment on websites and/or applications.

Note that the implementations herein have tremendous value even if a GUI designer still needs to modify the GUI design through the text-to-design process or within the GUI design tool. Reducing the design phase by even a few hours still increases the overall efficiency of the process. But most uses of the implementations herein will provide a much greater savings.

### A. Overall Architecture

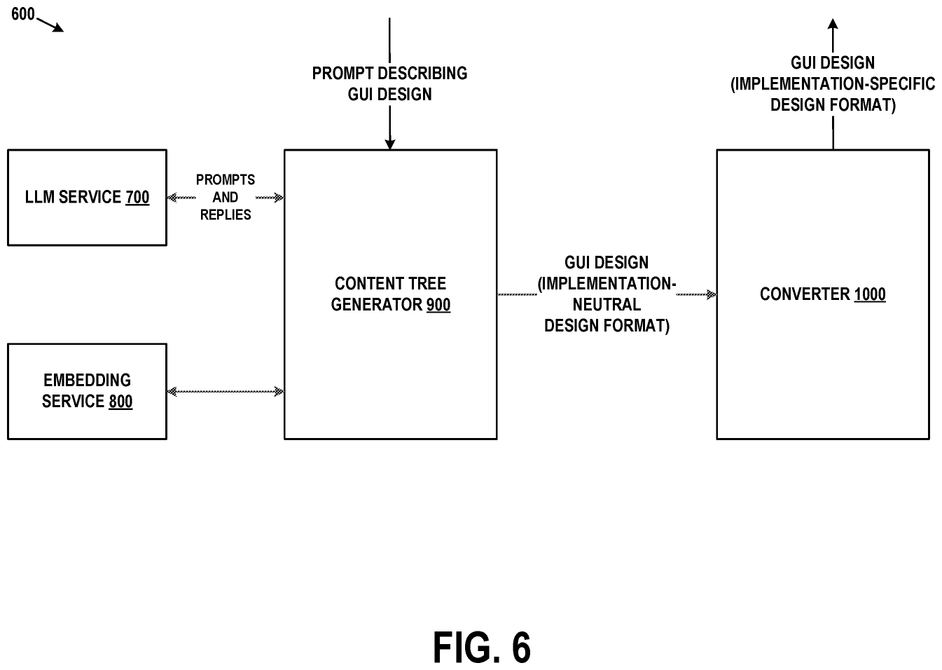

FIG. 6 depicts an overall architecture 600 for the text-to-design process. Architecture 600 includes software modules for LLM service 700, embedding service 800, content tree generator 900, and converter 1000. Nonetheless, more or fewer parts of overall architecture 600 may be present. Notably, overall architecture 600 supports multiple instances of converter 1000, each configured to generate a different implementation-specific design format (e.g., for respectively different GUI design tools).

LLM service 700 may be configured to receive a prompt (e.g., a textual description of a GUI) and use this prompt as the basis for a query to an LLM. The prompt may undergo pre-processing before it is submitted to the LLM in the form of the query, and the output provided by the LLM may undergo post-processing before it is returned as a reply to the prompt. Thus, LLM service 700 can be thought of as a “wrapper” or set of APIs around an LLM. While LLM service 700 may support text-based prompting and return text-based replies, it could be multimodal and thus also support non-text input and output.

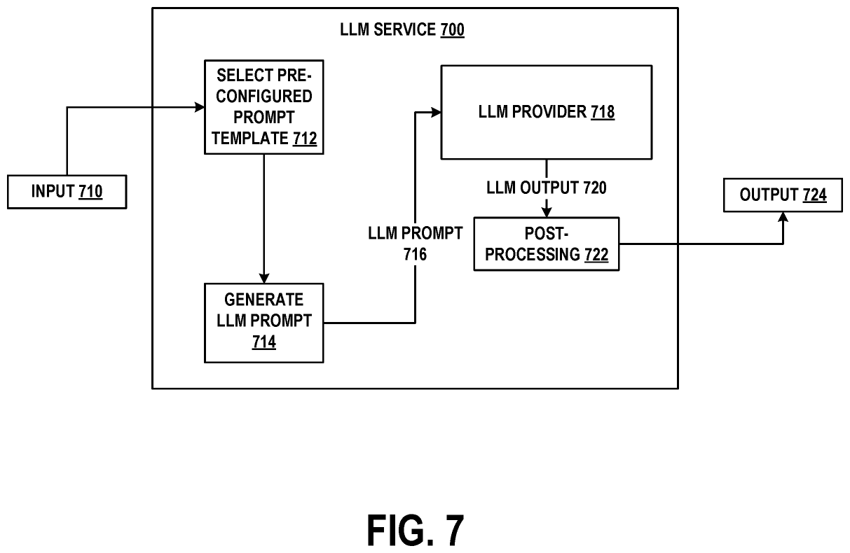

LLM service 700 will be described in more detail in the discussion of FIG. 7. For now, it can be assumed that LLM service 700 can receive prompts requesting it to produce content and LLM service 700 will produce the requested content.

Embedding service 800 may include a trained vector embedding model with mappings between: (i) vectors in n-space representing descriptions of predefined templates for GUI layouts, and (ii) template names. Embedding service 800 may also include a further trained vector embedding model with mappings between: (i) vectors in n-space representing descriptions of GUI components, and (ii) GUI component names. The GUI layouts may be thought of as respective collections of the GUI components.

Here, n may be 16, 128, 256, 512, or some other value. Different values of n may be used for each of the GUI layout mappings and the GUI component mappings.

Embedding service 800 may serve as a search function to identify (i) the template names of templates with similar vector representations to that of input text, (ii) the GUI component names of GUI components with similar vector representations to that of input text. In other words, given input text describing a GUI layout, embedding service 800 provides the names of one or more predefined GUI layout templates that have a similar GUI layout to what is described by the input text. Likewise, given input text describing a GUI component, embedding service 800 provides the names of predefined GUI component templates that are similar to what is described in the input text. These names could be any some of identifier (e.g., respectively unique alphanumeric strings).

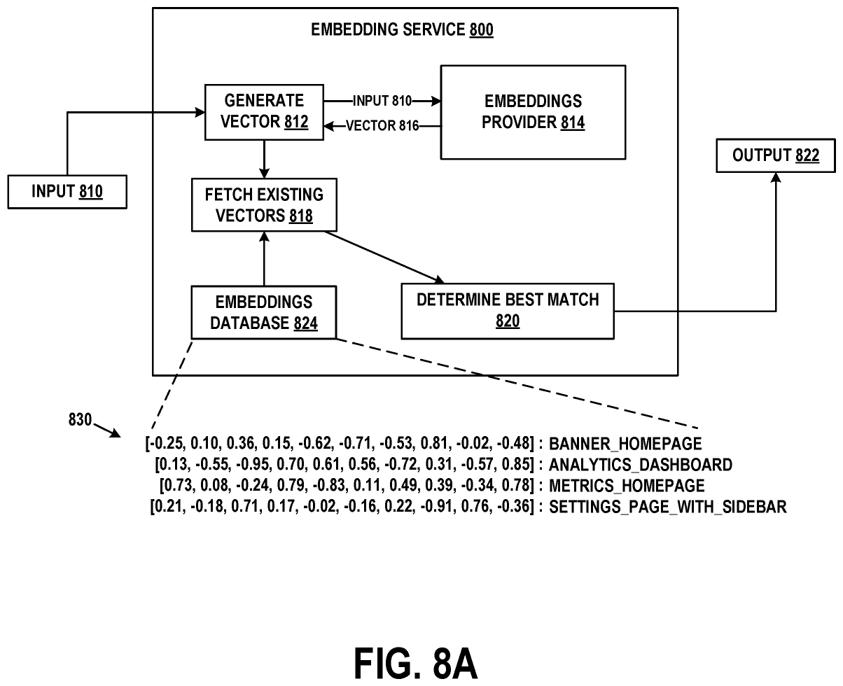

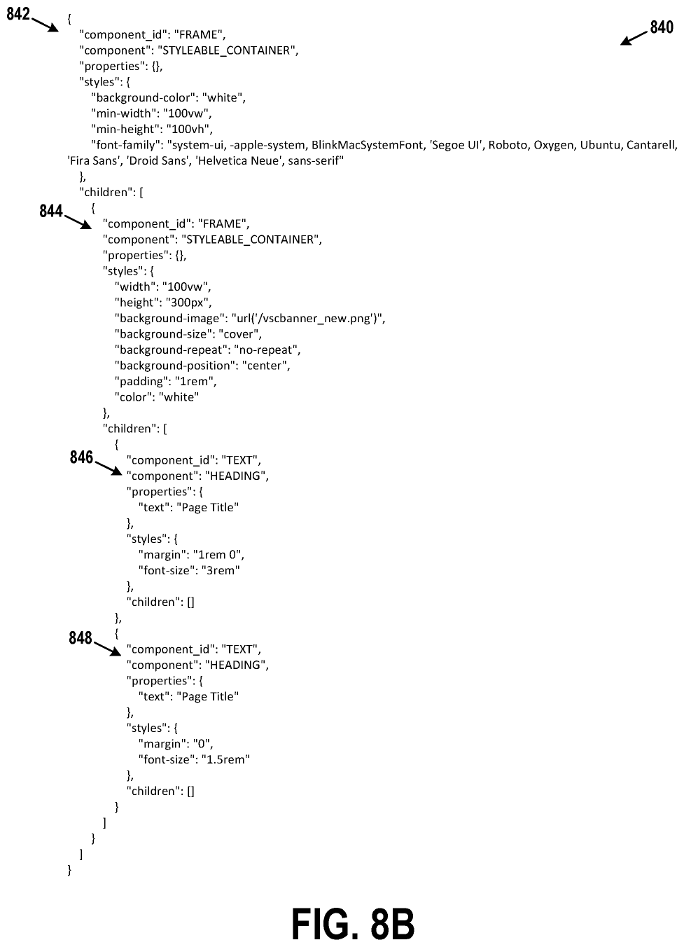

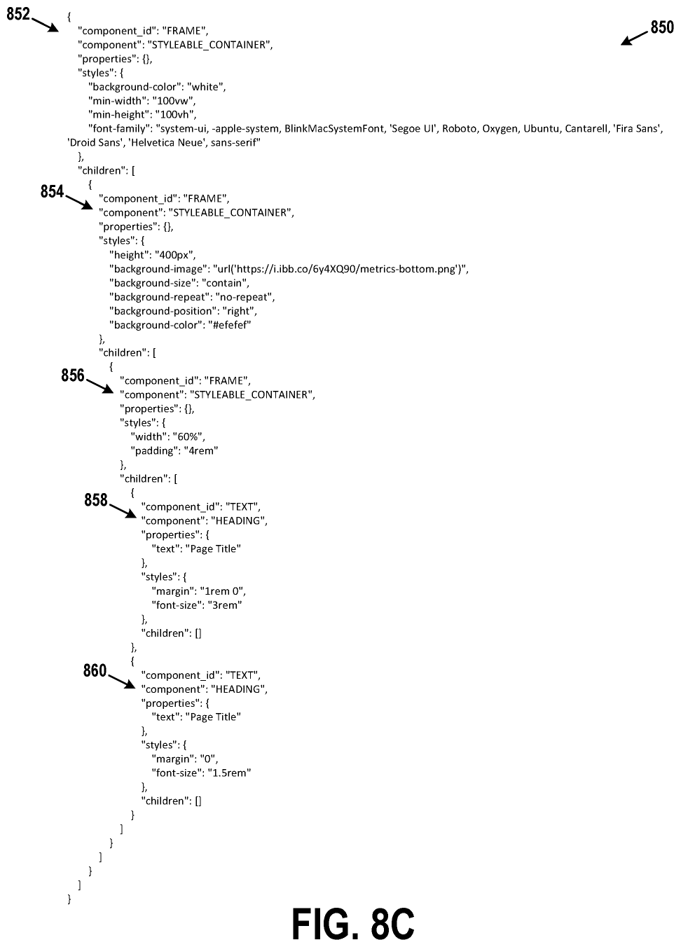

Embedding service 800 will be described in more detail in the discussion of FIGS. 8A, 8B, and 8C. For now, it can be assumed that embedding service 800 can receive descriptions of GUI layouts, and embedding service 800 will produce the names of contextually or semantically similar GUI layouts. Likewise, it can be assumed that embedding service 800 can receive descriptions of GUI components, and embedding service 800 will produce the names of contextually or semantically similar GUI components.

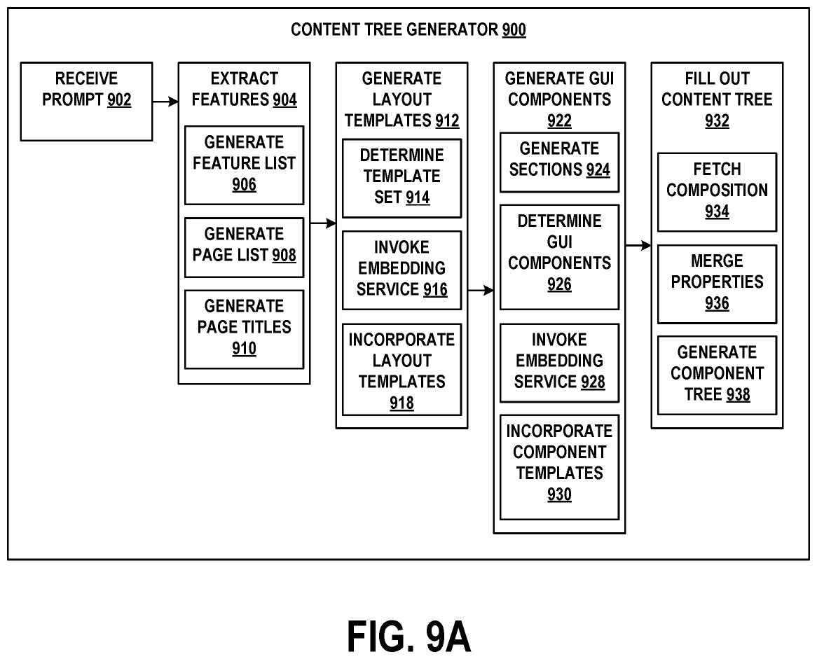

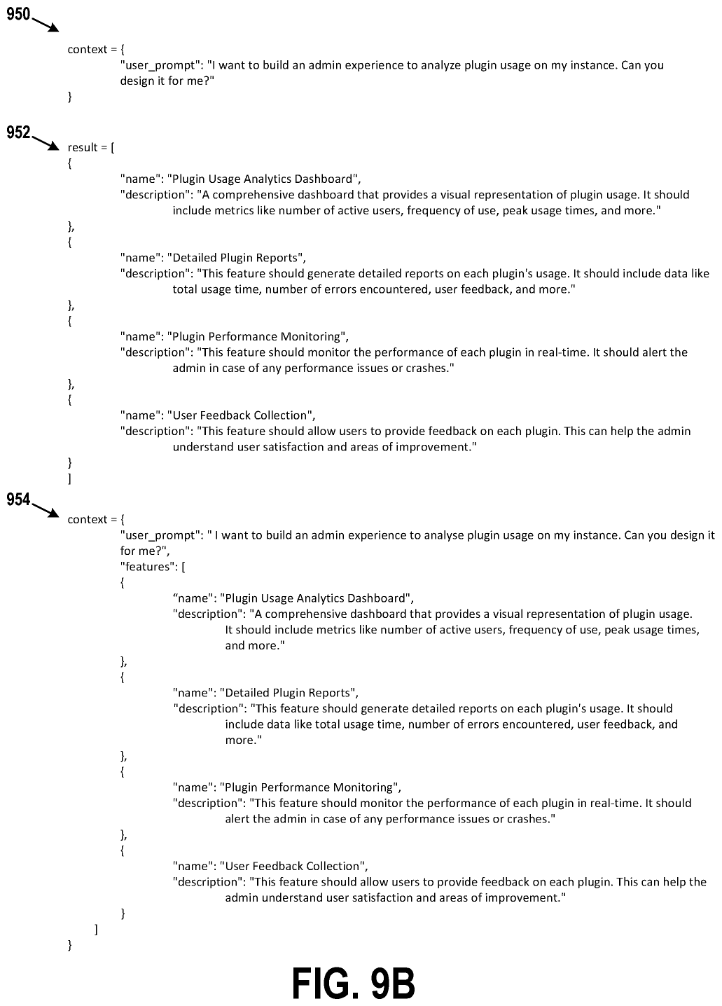

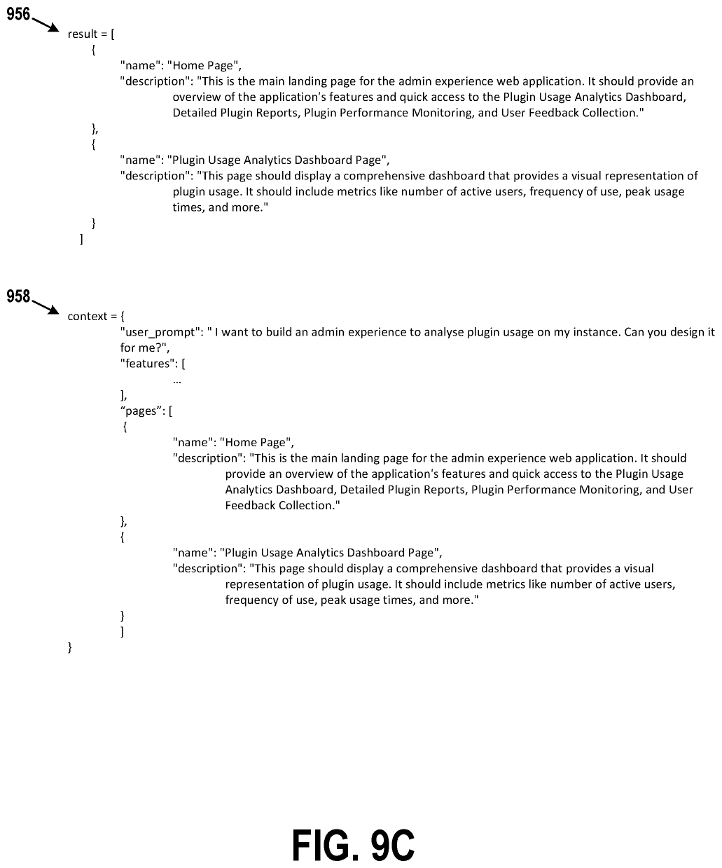

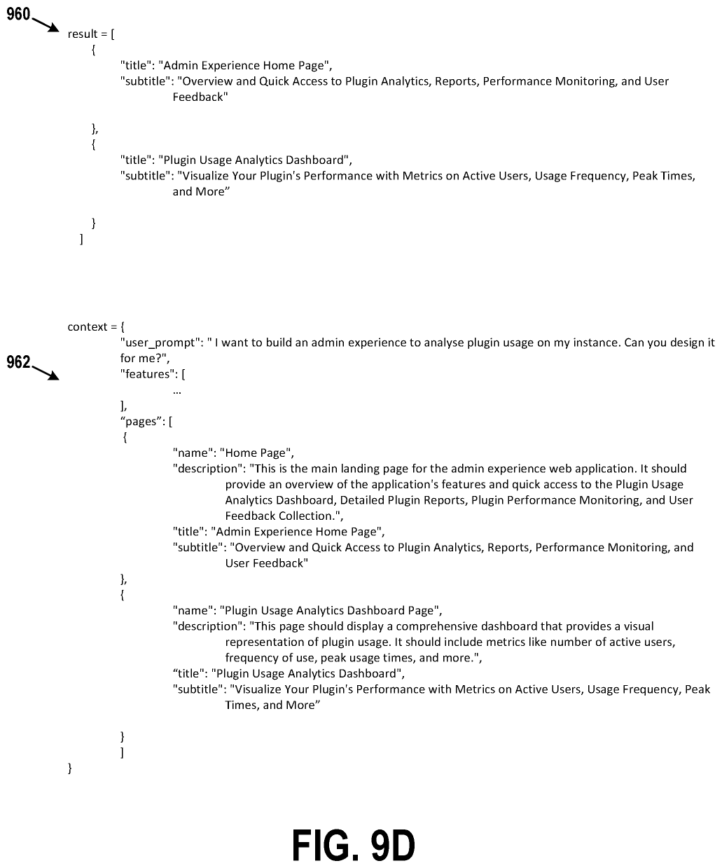

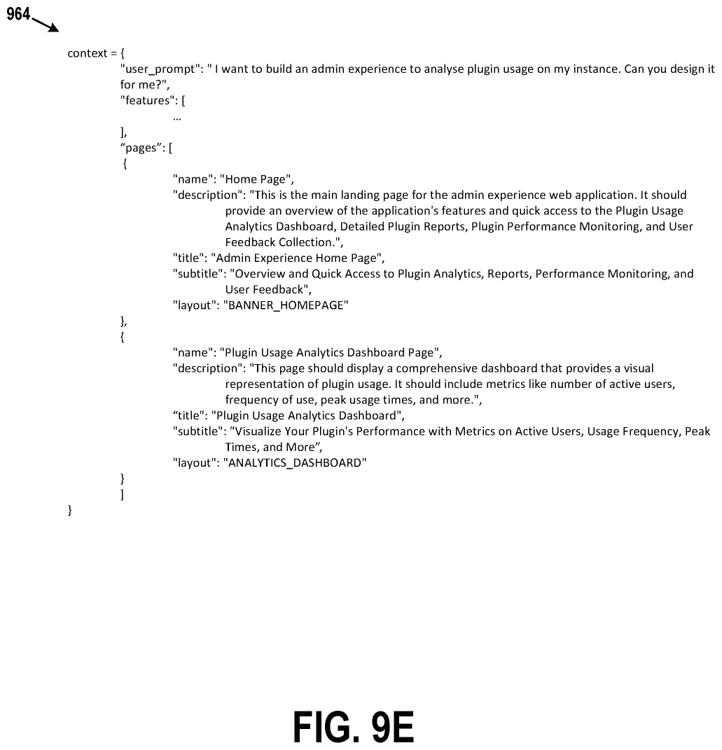

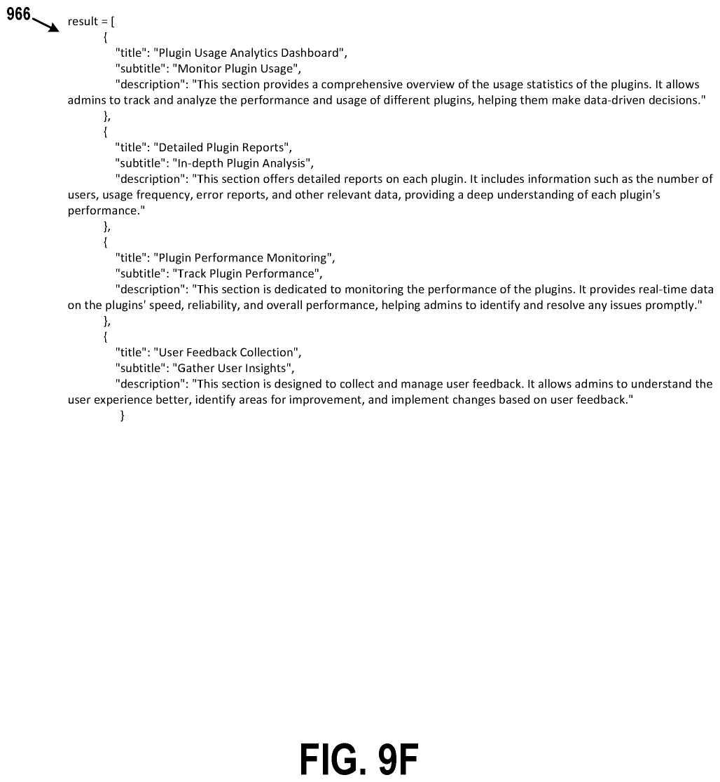

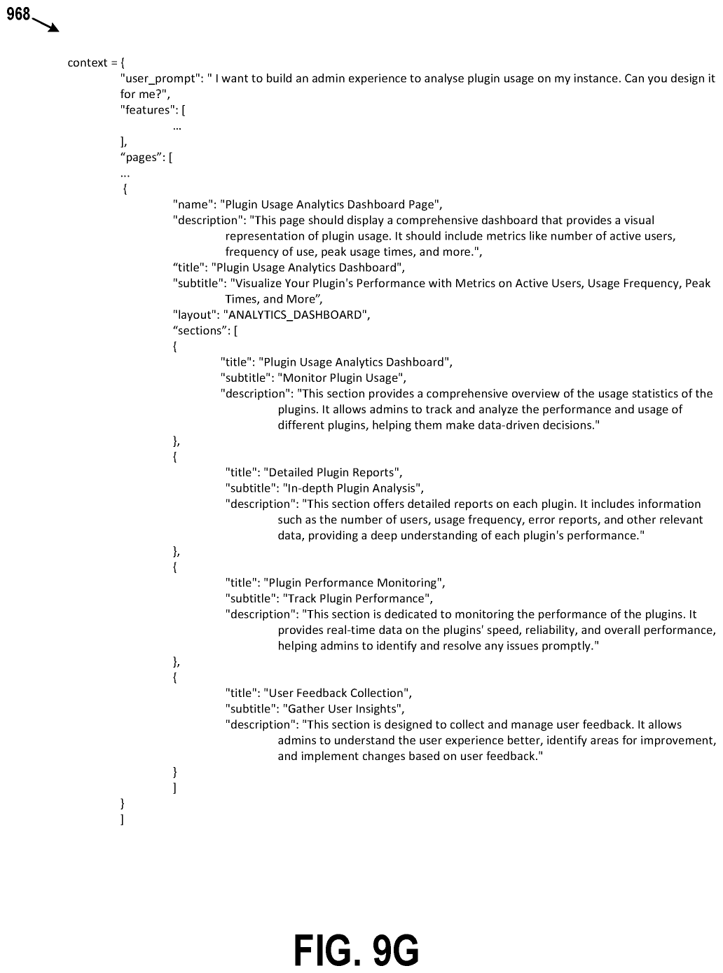

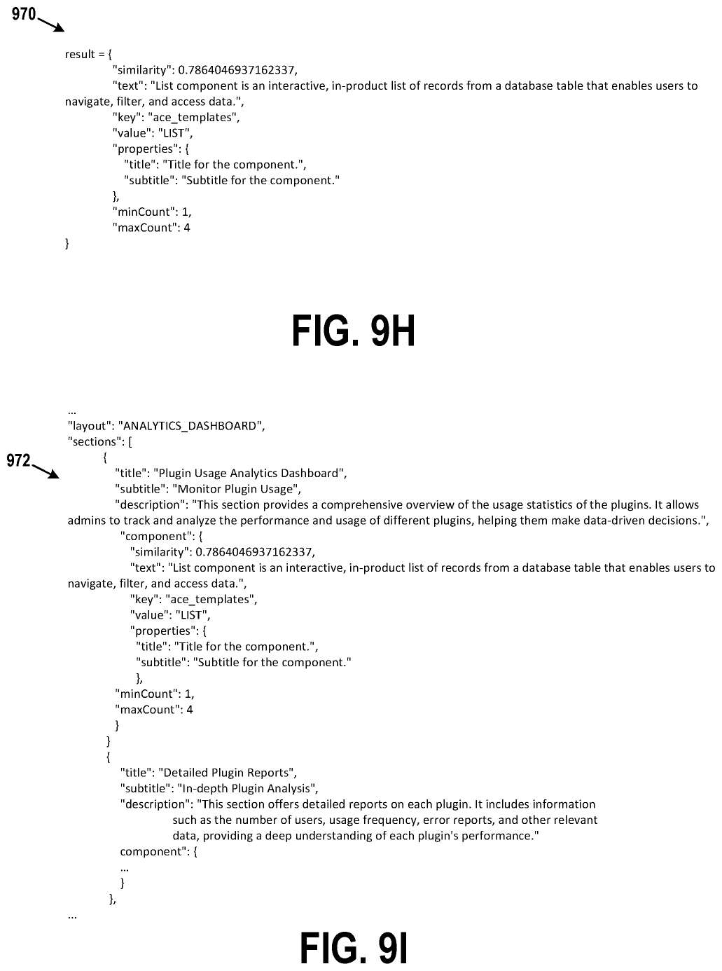

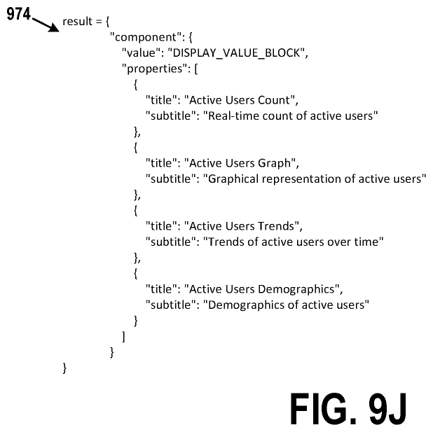

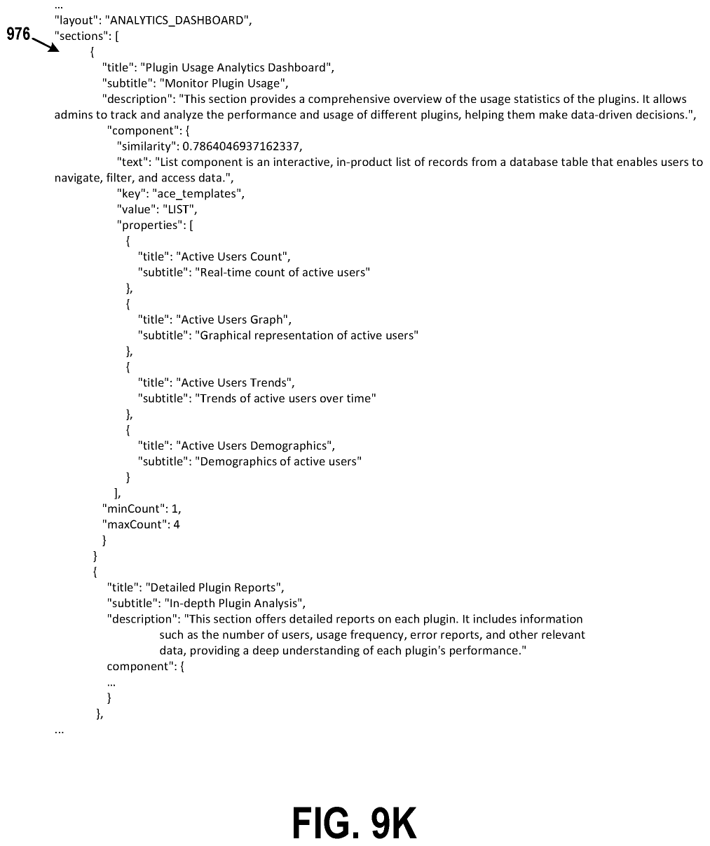

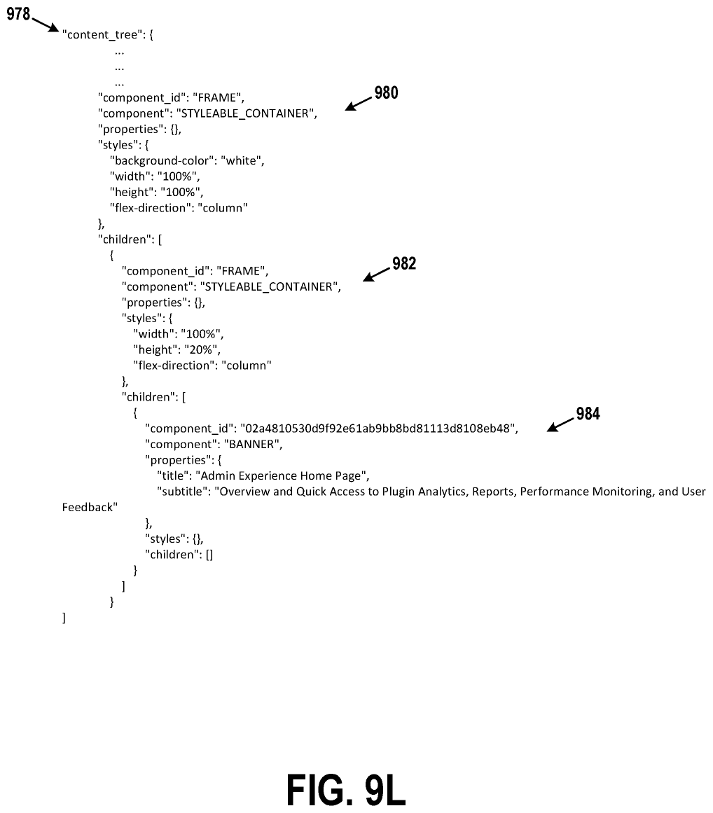

Content tree generator 900 may be configured to receive a prompt describing a GUI design and perform a series of steps based on this prompt to ultimately generate the GUI design in an implementation-neutral design format (e.g., metadata specifying the design programmatically in a content tree). The implementation-neutral design format may be provided as output from content tree generator 900. These steps will be described in more detail in the discussion of FIGS. 9A, 9B, 9C, 9D, 9E, 9F, 9G, 9H, 9I, 9J, 9K, and 9L. Notably, some steps may interact with LLM service 700 and/or embedding service 800.

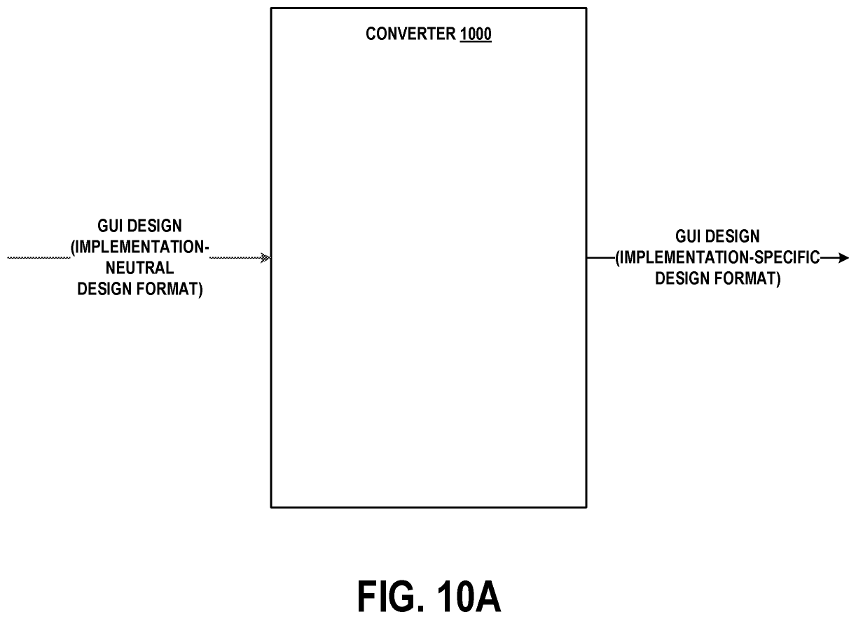

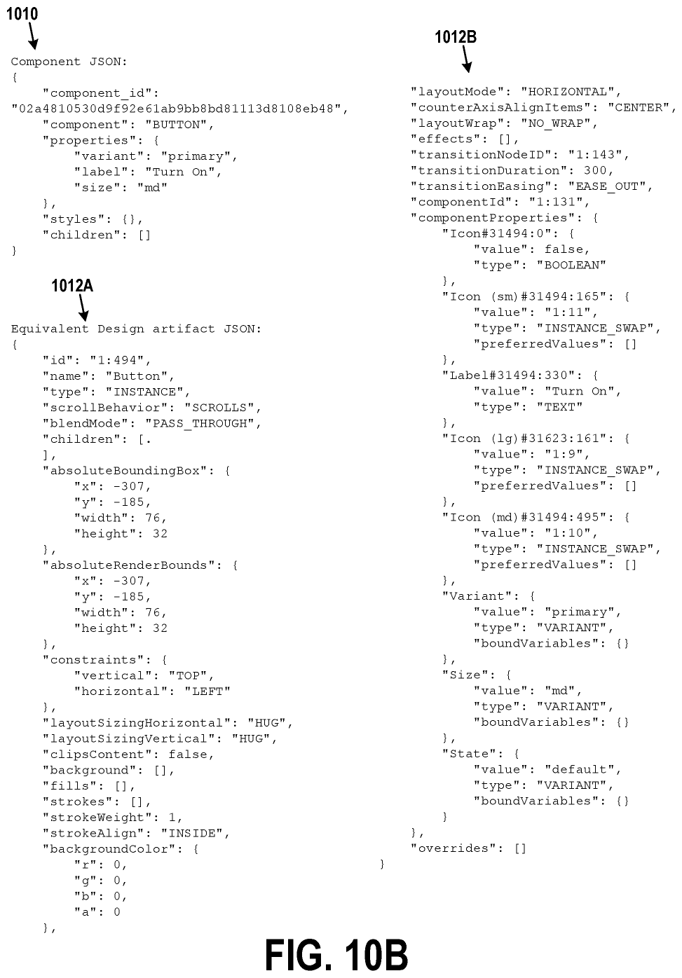

Converter 1000 may take the GUI design in the implementation-neutral design format (e.g., the output of content tree generator 900) and transform it into an implementation-specific design format. This implementation-specific design format may be the native format of or compatible with a specific design tool (e.g., FIGMAR, INVISION®, MIRO®, or various ADOBE® software packages). Doing so may involve converting attributes and GUI components of the GUI design in the implementation-neutral design format into a form supported by the implementation-specific design format, as well as filling in any attributes that are missing in the GUI design in the implementation-neutral design format but required by the implementation-specific design format. Converter 1000 will be described in more detail in the discussion of FIG. 10.

In various implementations, at least parts of LLM service 700, embedding service 800, content tree generator 900, and converter 1000 may operate on or be accessible to remote network management platform 320. Some aspects of these software modules may be located remotely from one another, such as LLM service 700 remotely invoking a third-party LLM (described in more detail below).

Also, architecture 600 itself might be remotely invoked, such as by a plugin module of a GUI design tool. In this case, the user of the GUI design tool would select the plugin module from the GUI design tool, causing the plugin module to execute. Then, the user would supply the prompt. The plugin module would transmit the prompt to remote network management platform 320 (for example). Remote network management platform 320 would invoke LLM service 700, embedding service 800, content tree generator 900, and converter 1000 on this prompt. Remote network management platform 320 would then provide the generated GUI design in the GUI design tool's format back to the design tool in response to the prompt. Other possibilities exist.

### B. LLM Service

An LLM is an advanced computational model, primarily functioning within the domain of NLP and machine learning. An LLM can be configured to understand, interpret, generate, and respond to human language in a manner that is both contextually relevant and syntactically coherent. The underlying structure of an LLM is typically based on a neural network architecture, more specifically, a variant of the transformer model. Transformers are notable for their ability to process sequential data, such as text, with high efficiency.

The operation of an LLM involves layers of interconnected processing units, known as neurons, which collectively form a deep neural network. This network can be trained on vast datasets comprising text from diverse sources, thereby enabling the LLM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LLM's output and expected output.

An aspect of an LLM's functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model's ability to generate contextually relevant and coherent text by understanding the relationships and dependencies between words or tokens in a sentence (or longer parts of texts), regardless of their position.

Upon receiving an input, such as a text query or a prompt, the LLM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LLM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LLMs highly versatile and applicable in various domains, including but not limited to, chatbot development, content creation, language translation, and sentiment analysis.

Some LLMs are multimodal in that they can receive prompts in formats other than text and can produce outputs in formats other than text. Thus, while LLMs are predominantly designed for understanding and generating textual data, multimodal LLMs extend this functionality to include multiple data modalities, such as visual and auditory inputs, in addition to text.

A multimodal LLM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LLM involves multimodal datasets, enabling the model to learn not only language patterns but also the correlations and interactions between different types of data. This cross-modal training results in multimodal LLMs being adept at tasks that require an understanding of complex relationships across multiple data forms, a capability that text-only LLMs do not possess. This makes multimodal LLMs particularly suited for advanced applications that necessitate a holistic understanding of multimodal information, such as chatbots that can interpret and produce images and/or audio.

As noted above, LLM service 700 can be thought of as a “wrapper” or set of APIs around an LLM. This aspect is illustrated by FIG. 7. In this figure, input 710, LLM prompt 716, LLM output 720, and output 724 generally represent data, while select pre-configured prompt template 712, generate LLM prompt 714, and post-processing 722 generally represent processing steps that act on data. LLM provider 718 may be a remotely accessible or local LLM system that can be communicated with by way of an LLM API.

LLM service 700 may receive input 710 from a calling entity. This input may be an input string or prompt from a module of content tree generator 900, for example, and possibly other contextual information as well (e.g., the type or class of information sought from LLM service 700. Thus, input 710 might be provided to LLM service 700 in the form of a function call such as:
call LLM_API(string, type)

Where string is an input string intended to be used as the basis of an LLM prompt, and type is an optional parameter that provides more information regarding the type of output that is desired.

Notably, input 710 may be referred to as a prompt and can be used as the basis for generation of LLM prompt 716. Thus, unless context suggests otherwise, the term “prompt” generally refers to input provided to LLM service 700 while the term “LLM prompt” generally refers to input that is used to invoke LLM provider 718.

The generation of an LLM prompt from input 710 may take place as follows. Select pre-configured prompt template 712 may determine, from the type parameter of input 710, the category of prompt template to be selected. Select pre-configured prompt template 712 may then select an appropriate prompt template from a library of one or more pre-configured prompt templates of that type.

Example types may include “GUI layout”, “application features”, “page list”, “page titles”, “page sections”, and so on. Functionality relating to each of these types will be described below.

For instance, if the type parameter of input 710 indicates “GUI layout”, select pre-configured prompt template 712 may choose a GUI layout prompt template with content relevant to the string parameter of input 710. Alternatively, there may be only one pre-configured template for GUI layout and the value of “GUI layout” in the type parameter may cause this GUI layout prompt template to be selected.

As an example, suppose that the GUI layout prompt template is “Given the user prompt for building a web application {X}, list and describe a set of up to {Y} features in {Z} format that should be a part of it.”. Here, {X}, {Y}, and {Z} are parameters that are filled in as discussed below. More or fewer parameters may be present.

Select pre-configured prompt template 712 may provide input 710 and the chosen GUI layout prompt template to generate LLM prompt 714. A goal of generate LLM prompt 714 is to produce LLM prompt 716 such that it is in a form understandable by LLM provider 718. Notably, generate LLM prompt 714 may fill in the values of {X}, {Y}, and {Z}. As an example, {X} may be replaced by the string parameter of input 710, {Y} may be replaced by a number, such as 3, 4, or 5, and {Z} may be replaced by an output format such as JSON or XML. In some cases, the value used for {Z} may also indicate element names for the output format. The values used for {Y} and {Z}, may be preconfigured or selected based on the content or context of input 710.

Putting this together, generate LLM prompt 714 may produce, as LLM prompt 716, “Given the user prompt for building a web application ‘I want to design an admin experience to analyze plugin usage on my instance’ list and describe a set of up to 3 features in JSON format that should be a part of it.” Then, LLM prompt 716 may be submitted to LLM provider 718, and LLM provider 718 may return LLM output 720 corresponding to the request. In the case of this example, LLM output 720 may be a few blocks of JSON elements that describe the requested 3 features of an admin experience for analyzing plugin usage.

Post-processing 722 may modify or transform LLM output 720 in various ways, such as changing element names, removing unnecessary whitespace, or otherwise formatting LLM output 720 into output 724. Then, LLM service 700 returns output 724 to the calling entity.

### C. Embedding Service

As noted above, embedding service 800 may include a trained vector embedding model with mappings between: (i) vectors in n-space representing descriptions of predefined templates for GUI layouts, and (ii) template names. Embedding service 800 may also include a further trained vector embedding model with mappings between: (i) vectors in n-space representing descriptions of GUI components, and (ii) GUI component names. Embedding service 800 may be used to determine templates and/or GUI components that suitably match textual descriptions thereof. Then, the matching templates and/or GUI components may be added to a GUI design.

FIG. 8A illustrates an example implementation of embedding service 800. In this figure, input 810, vector 816, output 822, and embeddings database 824 generally represent data, while generate vector 812, fetch vectors 818, and determine best match 820 generally represent processing steps that act on data. Embeddings provider 814 may be a remotely accessible or local embedding model that can be communicated with by way of an embeddings API.

Embeddings database 824 may contain mapped embeddings 830. Each of mapped embeddings 830 includes an n-dimensional vector (in this example, a vector of ten real numbers) associated with a name of a pre-defined layout template for a GUI. Each vector is a representation of its associated layout template based on one or more textual descriptions of this layout template. For example, the vector “[0.73, 0.08, −0.24, 0.79, −0.83, 0.11, 0.49, 0.39, −0.34, 0.78]” may be generated based on textual descriptions of metrics home pages. In general, more or fewer elements (e.g., numbers) can be used in each of these vectors. For instance, n could be 16, 128, 256, 512, or some other value.

Such vectors can be generated using various techniques. Some include term frequency-inverse document frequency or TF-IDF (words or tokens are represented as the product of their respective frequencies and the logarithm of the total number of documents divided by the number of documents containing the word), word embeddings (words or tokens are represented as weights of a hidden layer of a neural network that can predict target words or tokens from their surrounding contextual words or tokens), sentence embeddings (similar to word embeddings but with a document vector that numerically represents an entire document or section thereof in vector space), and/or bidirectional encoder representations from transformers or BERT (using self-attention mechanisms to create highly-contextualized number representations of words or tokens based on a window of surrounding words or tokens). Other possibilities exist.

Examples of predefined layout templates are shown in FIGS. 8B and 8C. FIG. 8B depicts a JSON definition 840 of the “BANNER_HOMEPAGE” layout template referred to in mapped embeddings 830. Similarly, FIG. 8C depicts a JSON definition 850 of the “ANALYTICS_DASHBOARD” layout template referred to in mapped embeddings 830.

JSON definition 840 specifies the “BANNER_HOMEPAGE” layout template in an explicit tree-based hierarchy. To that point, container 842 encapsulates container 844. Likewise, container 844 encapsulates heading 846 and heading 848. Likewise, JSON definition 850 specifies the “ANALYTICS_DASHBOARD” layout template also in an explicit tree-based hierarchy. To that point, container 852 encapsulates container 854, and container 854 encapsulates container 856. Likewise, container 856 encapsulates heading 858 and heading 860. Thus, each of these layout templates specify slightly different arrangements of components on a GUI.

While JSON definition 840 and JSON definition 850 specify relatively simple layout templates, other layout templates may be more complex. Regardless, the GUI layout of any GUI can be specified in this fashion.

Turning back to FIG. 8A, embeddings provider 814 contains or has access to a model that has been trained using such techniques and has produced mapped embeddings 830 accordingly. Mapped embeddings 830 may be stored locally (e.g., within embedding service 800) or remotely within embeddings provider 814. It is also assumed that embeddings provider 814 supports an API for producing vectors from input text according to its training. It is further assumed that embeddings provider 814 also contains a similar trained model for GUI component embeddings (not shown) as well as a similar API for accessing these embeddings.

Operationally, embedding service 800 may receive input 810. Input 810 may be a textual description of a GUI layout or a GUI component. Embedding service may submit input 810 to embeddings provider 814 and receive vector 816 in response. Vector 816 may be a vector embedding of input 810 in accordance with the trained GUI layout or GUI component model of embeddings provider 814.

Fetch existing vectors 818 may retrieve, from embeddings database 824, some or all embeddings for GUI layouts or GUI components, depending on which is requested. These may be mapped embeddings 830 for GUI layouts, as an example.

Determine best match 820 compares vector 816 to each of the vectors retrieved from mapped embeddings 830. This comparison may be used to identify the closest, or most similar vector to vector 816 within mapped embeddings 830. For example, cosine similarity, Euclidean distance, Manhattan distance, Jaccard similarity, or other calculations may identify this most similar vector.

For GUI layout templates, embedding service 800 may provide, as output 822, a template name or identifier of the layout template associated with the most similar vector. For GUI components, embedding service 800 may provide, as output 822, a GUI component name or identifier of the GUI component associated with the most similar vector.

### D. Content Tree Generator

FIG. 9A depicts the operation of content tree generator 900, which creates a GUI design in an implementation-neutral design format based on a prompt. The GUI design may be represented in JSON, XML, or some other type of structured markup language or file format. Herein, JSON is used for purposes of illustration. The GUI design may be specified as a tree with each node representing a GUI component and the relationships between nodes (e.g., parent-child, sibling) representing the GUI layout.

As shown in FIG. 9A, the processing of content tree generator 900 can be broken down into steps 902, 904, 912, 922, and 932. Some of these steps may have respective sets of substeps. Nonetheless, the representation of this processing as steps 902, 904, 912, 922, and 932 is just one arrangement and other sets of steps may be possible.

Receive prompt step 902 may involve content tree generator 900 receiving a prompt from a user, another application executing on remote network management platform 320, a remote system (e.g., a plugin executing within a design tool), or some other source. The prompt may be text (and used herein for purposes of examples) or multimodal in nature (e.g., some combination of text and image or text and audio).

As an example, a user could enter “I want to build an admin experience to analyze plugin usage on my instance. Can you design it for me?” Here, the user is requesting a GUI design for an administrative interface to investigate plugin usage within a computational instance of remote network management platform 320. This request will be used as a running example to illustrate how such a GUI design can be produced from a relatively simple prompt.

### 1. Extracting Features

Extract features step 904 may involve determining a set of features for the GUI design from the prompt. As shown, extract features step 904 may include substeps 906, 908, and 910, though more or fewer substeps may be present. Further, one or more of these substeps may invoke LLM service 700. Generally speaking, extract features step 904 involves iteratively constructing a context that defines more and more of the GUI design.

Generate feature list substep 906 may involve invoking LLM service 700 based on a version of the prompt to determine the main features of a GUI that would satisfy the request expressed by the prompt. Turning to FIG. 9B, the prompt may be placed in JSON structure 950, making it addressable as context.user_prompt. Then, context.user_prompt may be provided as the string parameter of input 710 to LLM service 700. A type parameter of “application features” may be provided in input 710. As described above, LLM service 700 may select a pre-configured prompt template based on the type parameter and/or other input and use this to generate an instance of LLM prompt 716.

Given the example context.user_prompt above, the selected prompt template may be:

“Given the user prompt for building a web application, “‘30 context.user_prompt+”’, list and describe a set of up to 4 features that should be a part of it. Answer in JSON array format where each feature is a separate object with ‘name’ as the key for the feature name and ‘description’ as the key for the feature description.”

In this and other such strings, the + sign indicates the string concatenation operator. Thus, LLM prompt 716 may include this pre-configured prompt template but with context.user_prompt replaced by “I want to build an admin experience to analyze plugin usage on my instance. Can you design it for me?”

Notably, this instance of LLM prompt 716 asks LLM provider 718 to generate four features in a JSON structure. More or fewer features may be requested.

The instance of LLM output 720 generated from this LLM input string is shown in JSON structure 952. The requested four features are Plugin Usage Analytics Dashboard, Detailed Plugin Reports, Plugin Performance Monitoring, and User Feedback Collection. Each of these features is accompanied by its respective description.

Post processing for generate feature list substep 906 may include concatenating JSON structure 950 and JSON structure 952 into JSON structure 954 through use of the command “context.features =result”. Thus, the names and descriptions of the features can be addressed within this structure using the context.features index into JSON structure 954.

Generate page list substep 908 may involve invoking LLM service 700 based on JSON structure 954 to determine pages of a GUI that would include the extracted features. For example, the text represented by the context.features index into JSON structure 954 may be provided to LLM service 700 as the string parameter to input 710. The type parameter to input 710 may be “page list”.

Herein, “pages” may refer to web pages of a web-based GUI or non-web-based screens of a GUI (e.g., screens, views, panels, windows, tabs, cards, frames, boxes, popups, or canvases of applications, interactive forms or dialogs, wizards, e-books, and so on). Other possibilities exist.

Given the type parameter of “page list” as well as possibly other information, the following pre-configured prompt template may be selected:
“Given the list of features and their descriptions for a web application, “‘+context.features+”’, list up to two required pages in the web application and describe them in a JSON array format. A home page is always required for an web application.”

Again, the + sign indicates the string concatenation operator. LLM prompt 716 may include this pre-configured prompt template but with context.features replaced by the string represented by context.features in JSON structure 954.

Notably, this instance of LLM prompt 716 asks LLM provider 718 to generate descriptions of two pages (one being a home page) in a JSON structure. More or fewer pages may be requested.

Turning to FIG. 9C, the instance of LLM output 720 generated from this LLM input string is shown in JSON structure 956. The requested page descriptions are titled Home Page and Plugin Usage Analytics Dashboard Page. Each of these titles is accompanied by its respective description. Note that it is the names and descriptions of the pages that are generated, rather than code for the pages themselves.

Post processing for generate page list substep 908 may include concatenating JSON structure 954 and JSON structure 956 into JSON structure 958 through use of the command “context.features=result”. Thus, the names and descriptions of the pages can be addressed within this structure using the “context.pages” index into JSON structure 958. Note that the representation of JSON structure 958 as shown in FIG. 9C replaces the content of the features array with an ellipsis (“ . . . ”) for sake of simplicity.

Generate page titles substep 910 may involve invoking LLM service 700 based on JSON structure 958 to determine titles and/or subtitles for each of the pages. For example, generate page titles substep 910 may iterate through each item i in the pages element of JSON structure 958 and assign pageName=context.page[i].name and pageDescription=context.page[i].description. Then, for each page, the respective values of pageName and pageDescription may be concatenated and provided to LLM service 700 as the string parameter of input 710. The type parameter to input 710 may be “page titles”.

As described above, LLM service 700 may select a pre-configured prompt template based on the type parameter and/or other input and use this to generate an instance of LLM prompt 716. Given the type parameter of “page titles”, the following pre-configured prompt template may be selected:
“Given page name, “‘+pageName+”’ and description, “‘+pageDescription+”’, generate an appropriate title and subtitle for the page in JSON format, with key as ‘title’ and ‘subtitle’ and values as the generated values.”

Again, the + sign indicates the string concatenation operator. The text from JSON structure 958 referenced by each of the pageName and pageDescription elements is inserted into the text of this pre-configured prompt template, resulting in multiple instances of LLM prompt 716. One instance of LLM prompt 716 is produced for each set of pageName and pageDescription elements. In other words, generate page titles substep 910 may involve LLM service 700 multiple times. Notably, these instances of LLM prompt 716 ask LLM provider 718 to generate titles and subtitles for each of the pages in a JSON structure.

As an example, pageName and pageDescription will respectively take on values of “Home Page” and “This is the main landing page for the admin experience web application. It should provide an overview of the application's features and quick access to the Plugin Usage Analytics Dashboard, Detailed Plugin Reports, Plugin Performance Monitoring, and User Feedback Collection” for the first page specified in JSON structure 958. Further, pageName and pageDescription will respectively take on values of “Plugin Usage Analytics Dashboard Page Page” and “This page should display a comprehensive dashboard that provides a visual representation of plugin usage. It should include metrics like number of active users, frequency of use, peak usage times, and more” for the second page specified in JSON structure 958.

Turning to FIG. 9D, the instance of LLM output 720 generated from these LLM prompts is shown in JSON structure 960. The requested titles are Admin Experience Home Page and Plugin Usage Analytics Dashboard. Each of these titles is accompanied by its respective subtitle.

Post processing for generate page titles substep 910 may include combining JSON structure 958 and JSON structure 960 into JSON structure 962. The representation of JSON structure 962 as shown in FIG. 9D replaces the content of the features array with an ellipsis (“ . . . ”) for sake of simplicity.

### 2. Generating Layout Templates

Generate layout templates step 912 may involve determining a set of templates for the GUI design from the context created so far. As shown, generate layout templates step 912 may include substeps 914, 916, and 918, though more or fewer substeps may be present. Further, one or more of these substeps may invoke embedding service 800. Generally speaking, generate layout templates step 912 involves identifying the names of templates for each of the pages specified by the process extract features step 904.

Determine template set substep 914 may involve identifying the layout templates that are to be requested. Doing so may be accomplished by iterating through each item i in the pages element of JSON structure 962 and assigning pageName=context.page[i].name and pageDescription=context.page[i].description.

Invoke embedding service substep 916 may be performed for each set of set of pageName and pageDescription elements. Thus, in the example of JSON structure 962, invoke embedding service substep 916 may be performed twice. An example of such an invocation is as follows:
call embeddingAPI (pageName+“ ”+pageDescription)

Again, the + sign indicates the string concatenation operator. The text from JSON structure 962 referenced by each of the pageName and pageDescription elements is inserted into the argument of the invocation of embeddingAPI. In this invocation, input 810 to embedding service 800 would be the argument to the embeddingAPI function, possibly with an indication that a layout template is sought. In generate vector 812, this instance of input 810 would be submitted to embeddings provider 814, and embeddings provider 814 would return a vector embedding of input 810 as vector 816.

Fetch existing vectors 818 of embedding service 800 may read the stored vector embeddings of GUI layouts from embeddings database 824. Determine best match 820 may identify the most similar vector of the stored vector embeddings to that of vector 816.

Output 822 may be a template name or identifier of the GUI layout associated with the most similar vector. For example, given the name and description of the “Home Page” specified in JSON structure 962, the template name “BANNER_HOMEPAGE” may be identified. Likewise, given the name and description of the “Plugin Usage Analytics Dashboard” specified in JSON structure 962, the template name “ANALYTICS_DASHBOARD” may be identified.

Incorporate layout templates substep 918 may involve adding indications of these template names to the specifications of their respective pages in JSON structure 962. The result of doing so may be JSON structure 964 of FIG. 9E. Notably, each template name appears in a “layout” element of its page's specification.

### 3. Generating GUI Components

Generate GUI components step 922 may involve determining a set of GUI components for the GUI design from the context created so far. As shown, generate GUI components step 922 may include substeps 924, 926, 928, and 930, though more or fewer substeps may be present. Further, one or more of these substeps may invoke LLM service 700 and/or embedding service 800. Generally speaking, generate GUI components step 922 involves, for each page, identifying the sections of the page and the GUI components that would constitute each section.

Generate sections substep 924 may involve identifying sections of each page specified in JSON structure 964. Doing so may be accomplished by iterating through each item i in the pages element of JSON structure 964 and assigning pageName=context.page[i].name and pageDescription=context.page[i].description.

Then, for each page, the respective values of pageName and pageDescription may be concatenated and provided to LLM service 700 as the string parameter of input 710. The type parameter to input 710 may be “page sections”.

As described above, LLM service 700 may select a pre-configured prompt template based on the type parameter and/or other input and use this to generate an instance of LLM prompt 716. Given the type parameter of “page sections”, the following pre-configured prompt template may be selected:
“Given a web page with name, “‘+pageName+”’, and description, “‘+pageDescription+”’, list and describe top four sections that should be a part of this page in JSON array format with each object containing the title, an appropriate subtitle for the section and description of the section. Return only the JSON array.”

Again, the + sign indicates the string concatenation operator. The text from JSON structure 964 referenced by each of the pageName and pageDescription elements is inserted into the text of this pre-configured prompt template, resulting in LLM prompt 716. One instance of LLM prompt 716 is produced for each set of pageName and pageDescription elements. In other words, generate sections substep 924 may involve LLM service 700 multiple times.

Turning to FIG. 9F, the instance of LLM output 720 generated for the Plugin Usage Analytics Dashboard Page is shown in JSON structure 966. The requested sections are titled Plugin Usage Analytics Dashboard, Detailed Plugin Reports, Plugin Performance Monitoring, and User Feedback Collection. Each of these titles is accompanied by its respective subtitle and description.

Post processing for generate sections substep 924 may include concatenating JSON structure 964 and JSON structure 966 into JSON structure 968 through use of the command “context.pages[i]. sections=result”. Thus, the names, subtitles, and descriptions of the sections of page i can be addressed within this structure using the “context.pages[i].sections” index. FIG. 9G depicts JSON structure 968. Note that this representation of JSON structure 968 focuses on the specification of the Plugin Usage Analytics Dashboard Page for sake of simplicity. Thus, the representation of JSON structure 968 as shown in FIG. 9G replaces the content of some of its parts with ellipses (“ . . . ”).

Determine GUI components substep 926 may involve identifying the GUI component templates that are to be requested. Doing so may be accomplished by iterating through each item j in the “sections” element of each item i in the “pages” element of JSON structure 968 and assigning section Title=context.page[i]. sections[j].title, sectionSubtitle context.page[i].sections[j].subtitle, and sectionDescription=context.page[i].sections[j]. description.

Invoke embedding service substep 928 may be performed for each set of set of sectionTitle, sectionSubtitle, and sectionDescription elements. Thus, in the example of JSON structure 968, invoke embedding service substep 928 may be performed four times for the Plugin Usage Analytics Dashboard Page. An example of such an invocation is as follows:
call embeddingAPI(sectionTitle+“ ”+sectionSubtitle+“ ”+sectionDescription)

Again, the + sign indicates the string concatenation operator. The text from JSON structure 968 referenced by each of the section Title, sectionSubtitle, and section Description elements is inserted into the argument of the invocation of embeddingAPI. In this invocation, input 810 to embedding service 800 would be the argument to the embeddingAPI function, possibly with an indication that a GUI component template is sought. In generate vector 812, this instance of input 810 would be submitted to embeddings provider 814, and embeddings provider 814 would return a vector embedding of input 810 as vector 816.

Fetch existing vectors 818 of embedding service 800 may read the stored vector embeddings of GUI layouts from embeddings database 824. Determine best match 820 may identify the most similar vector of the stored vector embeddings to that of vector 816. Output 822 may be a GUI component name or identifier of the GUI component associated with the most similar vector.

As an example, FIG. 9H depicts the result of applying embedding service 800 on the section titled “Plugin Usage Analytics Dashboard”. JSON structure 970 includes elements specifying the similarity score for the matching component, as well as a number of generic elements (e.g., text, properties, minCount, MaxCount). These generic elements may be filled out during generate content tree step 932. Notably, similar component specifications (e.g., in JSON format) may be returned for other components in JSON structure 968 as needed.

Incorporate component templates substep 930 may involve adding the JSON structures returned in invoke embedding service substep 928 to the specifications of their respective sections in JSON structure 968. FIG. 9I depicts JSON structure 972, which is a partial update to JSON structure 968 that includes the incorporation of JSON structure 970. As indicated by the ellipses, the rest of the JSON structure is omitted for simplicity. For context, all of the change to the section titled “Plugin Usage Analytics Dashboard” are shown along with partial changes to the section titled “Detailed Plugin Reports.”

Regardless, at the end of the incorporate component templates substep 930 a full tree representing a GUI design is described in a JSON structure. The JSON structure may be referred to as the context of the GUI.

### 4. Filling Out the Content Tree

Fill out content tree step 932 may involve transforming and/or accentuating the context developed for the GUI design so far. As shown, fill out content tree step 932 may include substeps 934, 936, and 938 though more or fewer substeps may be present. Further, one or more of these substeps may invoke LLM service 700. Generally speaking, fill out content tree step 932 involves, for each component element of a section (such as the one in FIG. 9I), filling out and/or expanding its “properties” element. LLM service 700 may be invoked a number of times to achieve this goal.

In fetch composition substep 934, LLM service 700 may be invoked with a pre-configured prompt template on the “properties” element of each component. The following is an example of such a pre-configured prompt template:
“Begin. Only respond in valid JSON. For a page described as, “‘+context.pages.description[i]+”’, here is a list of section details and corresponding components to be included in the page, “‘+context.pages.sections[i]+”’. For the given component, generate a set of “‘+minCount+”’ to “‘+maxCount+”’ number of appropriate values for all properties described in the ‘properties’ object, in the context of the component value and text and represent it as objects containing the property key as the keys and generated values as the value. Add these objects as an array to a field called ‘properties’. Keep the structure of the JSON response the same as the original array but do not include section description, section title, section subtitles or other component details. Include only the generated properties for a given section by itself. Return the modified array in JSON format.”

Again, the + sign indicates the string concatenation operator. The text from JSON structure 972 referenced by each of the context.pages.description[i] and context.pages.sections[i] elements may be inserted into the text of this pre-configured prompt template. An example of how these variables would be inserted into the prompt for the section titled “Plugin Usage Analytics Dashboard” is shown below:
“Begin. Only respond in valid JSON. For a page described as, ‘This page should display a comprehensive dashboard that provides a visual representation of plugin usage. It should include metrics like number of active users, frequency of use, peak usage times, and more’, here is a list of section details and corresponding components to be included in the page, ‘{“title”: “Plugin Usage Analytics Dashboard”, “subtitle”: “Monitor Plugin Usage”, “description”: “This section provides a comprehensive overview of the usage statistics of the plugins. It allows admins to track and analyze the performance and usage of different plugins, helping them make data-driven decisions.”, “component”: {“similarity”: 0.7864046937162337, “text”: “List component is an interactive, in-product list of records from a database table that enables users to navigate, filter, and access data.”, “key”: “ace_templates”, “value”: “LIST”, “properties”: {“title”: “Title for the component.”, “subtitle”: “Subtitle for the component.”}, “minCount”: 1, “maxCount”: 1}}’. For the given component, generate a set of 1 to 4 number of appropriate values for all properties described in the ‘properties’ object, in the context of the component value and text and represent it as objects containing the property key as the keys and generated values as the value. Add these objects as an array to a field called ‘properties’. Keep the structure of the JSON response the same as the original array but do not include section description, section title, section subtitles or other component details. Include only the generated properties for a given section by itself. Return the modified array in JSON format.”

One instance of such an LLM prompt may be produced for each the sections defined in JSON structure 968. In other words, fetch composition substep 934 may invoke LLM service 700 multiple times.

FIG. 9J depicts, in JSON structure 974, the result of such a call to LLM service 700 for the “properties” element of the section titled “Plugin Usage Analytics Dashboard” of JSON structure 972. Notably, LLM service 700 has returned an expanded version of the “properties” element with a total of four properties, each with this own title and subtitle. In this case, these properties are different metrics related to plugin usage.

Regarding the maxCount and minCount elements relating to a component, they define the numeric range of instances of that component that should be added to its section. As shown in JSON structure 972, minCount is 1 and maxCount is 4. In this case, LLM service 700 is at liberty to choose a number between 1 and 4 (e.g., randomly or based on other considerations) and generate that many sets of properties. As shown in JSON structure 974, it has generated 4 instances. Thus, the properties define the state of a single instance of a component but the maxCount and minCount elements define how many instances of the component is required for a given section. In some cases both maxCount and minCount are set to 1 so that the number of component instances per section is just 1. Setting maxCount and minCount to the same value facilitates situations where the number of properties in a section is fixed.

In merge properties substep 936, the “properties” element of JSON structure 974 can then be merged into the appropriate location in the context. FIG. 9K depicts doing so by replacing the “properties” element in JSON structure 972 with that of JSON structure 974. The result is shown in JSON structure 976. Notably, this replacement process would take place for the “properties” element of each section.

Taking a step back, the process as a whole has so far constructed the definition of a GUI by way of LLM prompts and GUI layout and component template mappings in a JSON structure. This process iteratively builds the GUI specification as shown in JSON structures 950, 954, 958, 962, 964, 968, 972, and 974, with the context element as the root.

In generate component tree substep 938, the entire JSON structure (i.e., everything that falls under the “context” element) may be converted into GUI layout and GUI component elements. A converted tree (referred to herein as a “content tree”) may be formed based on GUI layout template and GUI component template metadata, such as the JSON structures discussed in the context of FIG. 8A, 8B, and 8C. In some embodiments, this may involve, for each of the pages elements in the JSON structure, generating an associated node in the content tree. The overall structure of the content tree may match or at least be based on the tree-like form of the JSON structure defined by the “context” element.

An example partial content tree 978 is shown in FIG. 9L. Once again, JSON is used to format content tree 978, but other techniques could be used instead. The “content tree” element is the root node and recursively encapsulates a number of other nodes in various types of parent-child relationships defined by the encapsulation. Some of the intermediate nodes may be containers (as indicated by the “STYLEABLE_CONTAINER” value appearing in the “component” elements of nodes 980 and 982), and leaf nodes may be non-container components (as indicated by the “BANNER” value appearing the “component” element of node 984). This process will continue until the content tree is a complete representation of the GUI layout and GUI elements specified by the context. In some cases the content tree JSON can be appended existing JSON structure, but in other cases, the content tree JSON can exist separately (e.g., as a separate file).

A full content tree is not shown for sake of simplicity due to its size. Nonetheless, the content tree may be an example of the implementation-neutral design format described above.

### E. Converter

As shown in FIG. 10, converter 1000 may convert a GUI design in an implementation-neutral design format (e.g., that of the generated content tree) into a GUI design in an implementation-specific design format (e.g., that of FIGMA®, INVISION®, MIRO®, and/or various ADOBE® software packages). In line with the discussion above, there may be multiple versions or instances of converter 1000, one for each implementation-specific design format.

Converter 1000 may transform the content tree into design artifacts, progressing iteratively from GUI layouts to GUI components. The algorithm for this conversion may be based on forms of iterative tree traversal. For example, starting from the root node, the may identify containers and their properties, then proceed to each container to identify and generate design artifacts and their properties. Recursive algorithms like depth-first or breadth-first traversal may be used. The content tree guides this process by preserving the design's hierarchy. For each GUI component, rendering-specific code or metadata is generated based on the target implementation-specific design format. Optionally, machine learning models trained on design artifacts and their corresponding characteristics can be invoked to provide design artifact features with enhanced accuracy and fidelity.

As an example, there may be a pre-established one-to-one association between GUI components of the implementation-neutral design format and design artifacts of the implementation-specific design format of a given GUI design tool. Thus, each node in the content tree may be transformed into a similar or equivalent design artifact. Further, the elements of each node may be transformed into similar or equivalent parameters of its design artifact.

In some cases, an LLM may be invoked to facilitate some or all of these associations. For instance, assuming that a GUI component is defined in the variable myComponent, the following predefined LLM prompt could be used to generate a corresponding FIGMA® element:
“For the graphical user interface component defined as “‘+myComponent+”’ generate an equivalent Figma design artifact in metadata with all required Figma properties populated with values from the graphical user interface component. If the graphical user interface component does have one or more of the required Figma properties, populate these properties with reasonable default values.”

For converting styles to FIGMAR, each node in the content tree that is not a GUI component (e.g., an internal node/container) is represented by a FRAME node in FIGMA®. The FRAME node representation is created by replicating the individual CSS style properties for the container. This can be accomplished by way of a FIGMAR API that allows application of these styles directly to a FRAME.

For converting GUI components to design artifacts, an appropriate design artifact (the GUI design equivalent of a GUI component) is selected for each GUI component. This is possible since the final content tree contains the component ID from FIGMA®. For example, there may be a pre-established one-to-one mapping between GUI components and corresponding design artifacts.

The design artifact would have sufficient details with respect to the property definitions. For example, if it is a button GUI component, the corresponding design artifact side would have properties like “variant”, “label”, etc. These property values would be present in the GUI component represented in the content tree as well. These are mapped together and a design artifact with those properties are added to the design file (e.g., by way of the FIGMA® API).

FIG. 10B depicts representations of a GUI component and its corresponding FIGMA® design artifact. Notably, GUI component 1010 represents a button and design artifact 1012A and 1012B represents a corresponding button in FIGMA®. The text of design artifact 1012A and 1012B has been split into two columns for purposes of presentation, but is intended to be a single JSON structure.

As discussed above, other GUI components may have corresponding design artifacts with mapped properties. Thus, the embodiments herein are not limited to the examples provided.

### VIII. Example Technical Improvements

These embodiments provide a technical solution to a technical problem. One technical problem being solved is the development of GUI designs customized in formats usable by specific GUI design tools. In practice, this endeavor is problematic because the specification of such GUI designs can take an excessive amount of time when using just the GUI design tools themselves.

In the prior art, GUI designers would typically create detailed wireframes (e.g., line and block diagrams of a GUI) in a GUI design tool to lay out basic GUI structure. Then, these GUI designs would often be revised multiple times to meet design requirements and based on feedback from software developers. Finalizing such a GUI design with transitions, animations, and/or hover effects, for example, can be technically complicated. Moreover, the prior art relies on subjective decisions and experiences of GUI designers, which leads to wildly varying outcomes from instance to instance. Thus, prior art techniques did little if anything to address uniformity in terms of technical implementation, much the less look-and-feel across GUIs.

The embodiments herein overcome these limitations by enabling GUI designers to generate GUI designs in native design tool format through use of one or more text prompts. Particularly, these implementations introduce an iterative process for employing LLMs and pre-established GUI layout and GUI component embeddings to generate an implementation-neutral representation of a GUI design in the form of a content tree. This implementation-neutral representation can be transformed into an implementation-specific representation that can be loaded into a GUI design tool. Accordingly, GUI design can be accomplished in a faster and more robust fashion. This results in several advantages. First, GUI designs can be modified easily by either regenerating them with a modified set of text prompts or by loading the implementation-specific representation into a GUI design tool for editing. Second, through the use of APIs to the LLM and embedding services, GUI designs can be made more consistent in terms of theme (e.g., graphics, colors and fonts). Third, with these advances, the GUI design process can be reduced from taking days or weeks to taking hours.

Other technical improvements may also flow from these embodiments, and other technical problems may be solved. Thus, this statement of technical improvements is not limiting and instead constitutes examples of advantages that can be realized from the embodiments.

### IX. Example Operations

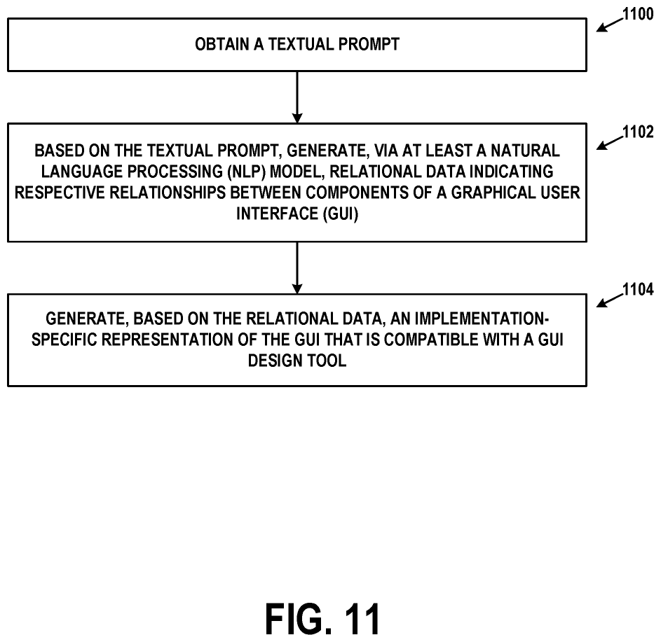

FIG. 11 is a flow chart illustrating an example embodiment. The process illustrated by FIG. 11 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 11 may be simplified by the removal of any one or more of the features shown therein. Further, these embodiments may be combined with features, aspects, and/or implementations of any of the previous figures or otherwise described herein.

Block 1100 may involve obtaining a textual prompt.

Block 1102 may involve, based on the textual prompt, generating, via at least an NLP model, relational data indicating respective relationships between components of a GUI.

Block 1104 may involve generating, based on the relational data, an implementation-specific representation of the GUI that is compatible with a GUI design tool.

In some implementations, the respective relationships between the components collectively represent an arrangement of the components within the GUI.

In some implementations, the components are represented in the relational data as nodes of a tree-like structure.

In some implementations, generating the relational data includes determining characteristics of the tree-like structure and the components.

In some implementations, generating the relational data includes invoking an embedding model that maps textual descriptions of the components to predefined specifications of the components.

In some implementations, invoking the embedding model comprises causing the embedding model to: determine an n-dimensional vector from a textual description of a component; match, using a similarity technique, the n-dimensional vector to a pre-defined n-dimensional vector associated with a predefined specification of a component; and return the predefined specification of the component as a result of invoking the embedding model.

In some implementations, generating the relational data includes invoking an embedding model that maps textual descriptions of one or more layouts related to the GUI to predefined specifications of the one or more layouts.

In some implementations, generating the relational data comprises a plurality of invocations of the NLP model that iteratively define the respective relationships between the components.

In some implementations, the plurality of invocations include invoking the NLP model to: generate a list of GUI features based on the textual prompt; generate a list of GUI pages based on the list of GUI features; and generate a list of page titles, one for each of the GUI pages.

In some implementations, the NLP model is a transformer-based large language model.

In some implementations, generating the relational data comprises adding at least some of the textual prompt to a pre-defined NLP prompt.

In some implementations, the relational data is specified in JSON metadata or XML metadata as a hierarchy of elements that define the components and the respective relationships.

In some implementations, generating the implementation-specific representation comprises applying a one-to-one mapping between the components and design artifacts supported by the GUI design tool.

### X. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining a textual prompt;
based on the textual prompt, generating, via at least a natural language processing (NLP) model, relational data indicating respective relationships between components of a graphical user interface (GUI); and
generating, based on the relational data, an implementation-specific representation of the GUI that is compatible with a GUI design tool.

2. The method of claim 1, wherein the respective relationships between the components collectively represent an arrangement of the components within the GUI.

3. The method of claim 1, wherein the components are represented in the relational data as nodes of a tree-like structure.

4. The method of claim 3, wherein generating the relational data includes determining characteristics of the tree-like structure and the components.

5. The method of claim 1, wherein generating the relational data includes invoking an embedding model that maps textual descriptions of the components to predefined specifications of the components.

6. The method of claim 5, wherein invoking the embedding model comprises causing the embedding model to:
determine an n-dimensional vector from a textual description of a component;
match, using a similarity technique, the n-dimensional vector to a pre-defined n-dimensional vector associated with a predefined specification of the component; and
return the predefined specification of the component as a result of invoking the embedding model.

7. The method of claim 1, wherein generating the relational data includes invoking an embedding model that maps textual descriptions of one or more layouts related to the GUI to predefined specifications of the one or more layouts.

8. The method of claim 1, wherein generating the relational data comprises a plurality of invocations of the NLP model that iteratively define the respective relationships between the components.

9. The method of claim 8, wherein the plurality of invocations include invoking the NLP model to:
generate a list of GUI features based on the textual prompt;
generate a list of GUI pages based on the list of GUI features; and
generate a list of page titles, one for each of the GUI pages.

10. The method of claim 1, wherein the NLP model is a transformer-based large language model.

11. The method of claim 1, wherein generating the relational data comprises adding at least some of the textual prompt to a pre-defined NLP prompt.

12. The method of claim 1, wherein the relational data is specified in JavaScript Object Notation (JSON) metadata or extensible Markup Language (XML) metadata as a hierarchy of elements that define the components and the respective relationships.

13. The method of claim 1, wherein generating the implementation-specific representation comprises applying a one-to-one mapping between the components and design artifacts supported by the GUI design tool.

14. A non-transitory computer-readable medium, having stored thereon program instructions that, upon execution by a computing system, cause the computing system to perform operations comprising:
obtaining a textual prompt;
based on the textual prompt, generating, via at least a natural language processing (NLP) model, relational data indicating respective relationships between components of a graphical user interface (GUI); and
generating, based on the relational data, an implementation-specific representation of the GUI that is compatible with a GUI design tool.

15. The non-transitory computer-readable medium of claim 14, wherein generating the relational data includes invoking an embedding model that maps textual descriptions of the components to predefined specifications of the components.

16. The non-transitory computer-readable medium of claim 15, wherein invoking the embedding model comprises causing the embedding model to:
determine an n-dimensional vector from a textual description of a component;
match, using a similarity technique, the n-dimensional vector to a pre-defined n-dimensional vector associated with a predefined specification of the component; and
return the predefined specification of the component as a result of invoking the embedding model.

17. The non-transitory computer-readable medium of claim 14, wherein generating the relational data comprises a plurality of invocations of the NLP model that iteratively define the respective relationships between the components.

18. The non-transitory computer-readable medium of claim 17, wherein the plurality of invocations include invoking the NLP model to:
generate a list of GUI features based on the textual prompt;
generate a list of GUI pages based on the list of GUI features; and
generate a list of page titles, one for each of the GUI page.

19. The non-transitory computer-readable medium of claim 14, wherein generating the implementation-specific representation comprises applying a one-to-one mapping between the components and design artifacts supported by the GUI design tool.

20. A system comprising:
one or more processors; and
memory, containing program instructions that, upon execution by the one or more processors, cause the system to perform operations comprising:
obtaining a textual prompt;
based on the textual prompt, generating, via at least a natural language processing (NLP) model, relational data indicating respective relationships between components of a graphical user interface (GUI); and
generating, based on the relational data, an implementation-specific representation of the GUI that is compatible with a GUI design tool.
